(19) United States
(12) Patent Application Publication
(10) Pub. No.: US 2005/0014621 A1
(43) Pub. Date: Jan. 20, 2005

(54) Method of reducing folding resistance and correcting score line misregister and product of the method

(76) Inventor: Jack A. McClure, Omaha, NE (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 10/620,788

(22) Filed: Jul. 15, 2003

(51) Int. Cl. B31B 1/25

(52) U.S. Cl. 493/59

(57) ABSTRACT

The present invention is directed to a method of reducing a container's folding resistance, and improving a container's overall ability to tolerate score line misregister. The method includes forming a container blank having a panel wherein the panel includes a score line. Also, the method includes interposing a relief region along the score line, wherein the score line is aligned with the relief region. The relief region includes a plurality of relief profiles or cuts through the blank/container's material. The relief profiles may be of any geometric shape.

### FIELD OF THE INVENTION

This invention relates generally to containers and, more specifically to a method of reducing a container's folding resistance and improving a container's overall ability to tolerate score line misregister.

### BACKGROUND OF THE INVENTION

Wood cellulose containers are extremely well known in the art. Typically, they are formed from a single or multiple sheet of containerboard material that is cut, scored, folded and secured together to form a container or insert of a desired configuration.

There are problems with the current container forming process. One problem with the current forming process is an excessive amount of folding resistance required to erect a container from a blank, especially when using a relatively thick material, such as double or triple wall corrugated containerboard. The excessive folding resistance often increases the overall difficulty of completing the formation of the container. Additionally, when blanks are formed, often score lines on adjacent or overlapping panels are misaligned. This score line misalignment, or alignment error, often adversely affect container formation.

### SUMMARY OF THE INVENTION

The present invention is directed to a method of reducing a container's folding resistance, and improving a container's overall ability to tolerate score line misregister, or alignment error. The method includes forming a container blank having a panel wherein the panel includes a score line. Also, the method includes interposing a relief region along the score line, wherein the score line is aligned with the relief region. The relief region includes a plurality of relief profiles or cuts through the blank/container's material. The relief profiles may be of any geometric shape.

The present invention also includes a blank and a container formed with a relief region interposed along a score line. Specifically, the score line is aligned with but does not extend though the relief region. In this manner, a blank may be formed into a container in a more reliable and folding force efficient manner.

### BRIEF DESCRIPTION OF THE DRAWINGS

The preferred and alternative embodiments of the present invention are described in detail below with reference to the following drawings.

FIG. 1 is a plan view of a portion of a container blank according to the present invention;

FIG. 2 is an isolated plan view of the an embodiment of the relief section in accordance with the present invention;

FIG. 3 is another isolated plan view of an embodiment of the relief section made in accordance with the present invention;

FIG. 4 is a plan view of a container blank including aspects of the present invention; and,

FIG. 5 is a perspective view of a container formed from the blank of FIG. 4.

### DETAILED DESCRIPTION OF THE INVENTION

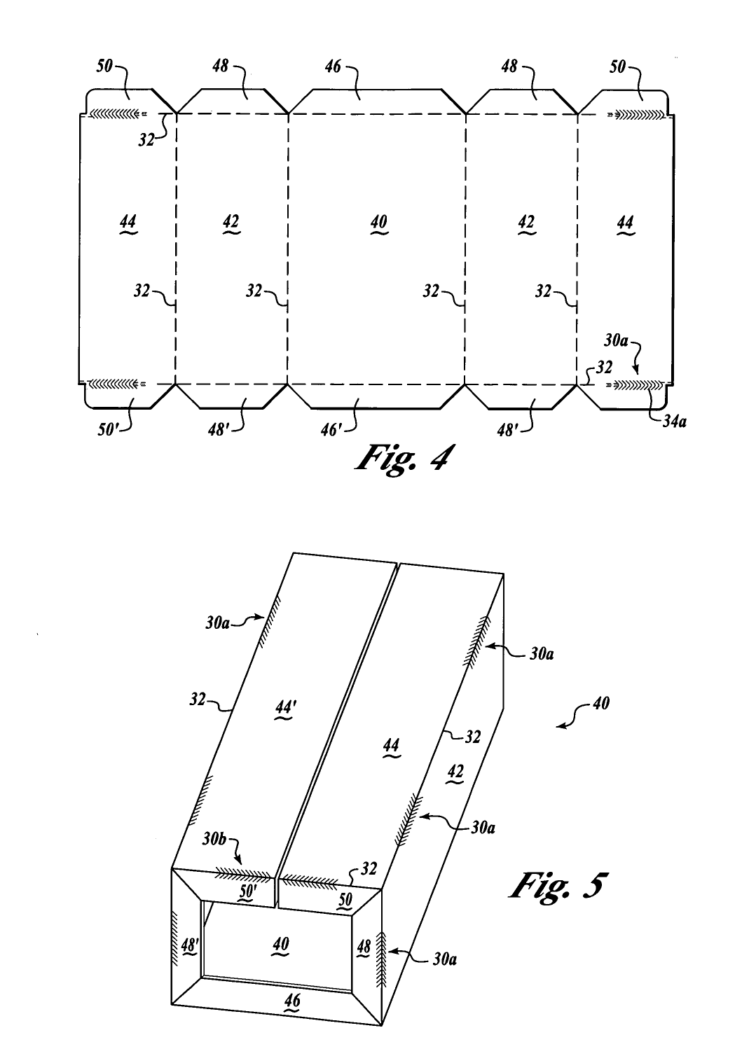

The present invention will now be described with reference to the accompanying drawings. The present invention is directed to a method of reducing a container's folding resistance, and improving a container's overall ability to tolerate score line misregister, or alignment error. One suitable embodiment of a container 60 constructed in accordance with the present invention is illustrated in FIG. 5. Further attributes of the present invention are illustrated in FIG. 4. Specific details of the present invention are described with more particularity below.

The present invention is preferably formed from containerboard. However, other materials are considered within the scope of this invention, such as, without limitation, paperboard, fibreboard, corrugated containerboard, single wall corrugated containerboard, double wall corrugated containerboard and triple wall corrugated containerboard. As such, the material from which the blank 38 and container 60 are constructed from are not considered limitations to the present invention.

A blank 38 is cut, scored, perforated or otherwise formed to include a plurality of panels which, when assembled, form container 60. Wherever possible, the same number is used to in related panels of the container 60. More specifically, in all FIGURES, like numbers indicate like parts. Additionally, cuts are shown as solid lines, score lines as dashed lines and lines of perforation as broken lines.

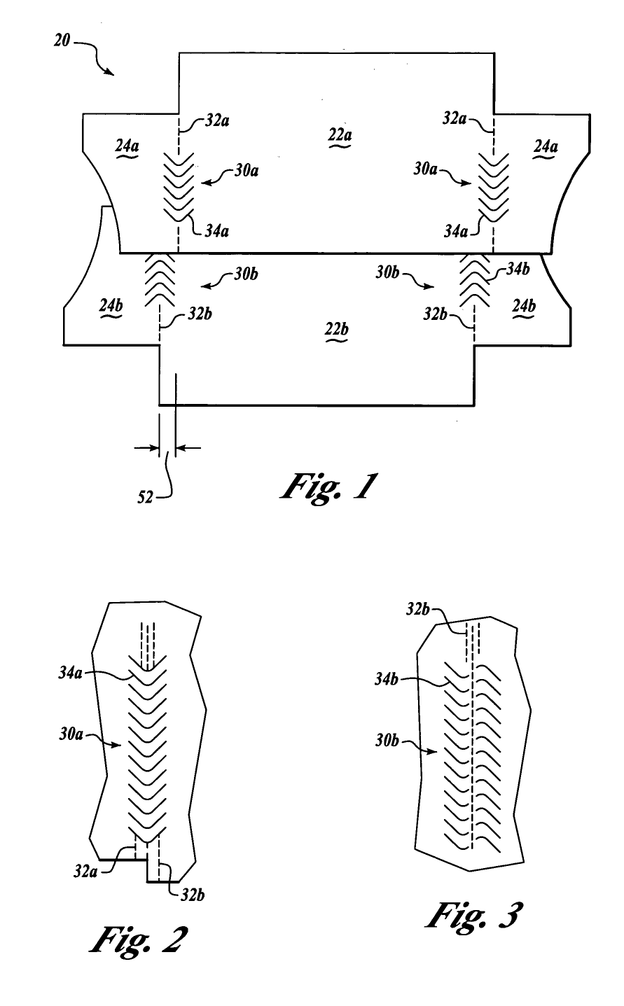

FIG. 1 depicts an aspect of the present invention. Specifically, an assembly 20 is shown as including overlapping panels 22a,b and flaps 24a,b, that are adhered together as is commonly know in the container arts. Each panel 22a,b is hingedly attached to opposed panels flaps 24a,b via score lines 32a,b. Interposed with at least one of the score lines 32a,b are relief region 30a,b. For the purposes of this application, by interposed, it is meant that for each relief region 30a,b, the associated score line 32a,b is aligned with the relief region 30a,b. Preferably, the relief region 30a,b is aligned with the associated score line 32a,b such that the score line does not extend through the relief region 30a,b. However, a configuration where the associated score line 32a,b does extend partially or fully through the relief region 30a,b is also within the scope of this invention.

The relief region 30a,b includes a plurality of relief profiles 34a,b. The relief profiles 34a,b are arranged cuts that lie substantially transverse the score lines 32a,b within the relief region 30a,b. As best seen in FIGS. 2 and 3, the relief profiles 34a,b may be of any geometric shape. As seen is FIG. 3, the relief profiles 34a,b are S-shaped, while in FIG. 2 the relief profiles 34a,b are substantially V-shaped. Still other shapes are considered within the scope of this invention, such as, without limitation, C-shaped (not shown), U-shaped (not shown) or any other known geometric shape the may be placed transverse of the score lines 32a,b.

With reference to FIGS. 1-3, a unique aspect of the present invention is disclosed. Specifically, the relief regions 30a,b helps correct any panel misalignment or alignment error 52 that results during formation of the container 60. As is well known in the art, relative panel movement may occur just prior to or during the fastening of two or more panels together. Typically, all panels are cut and scored prior to forming the container 60, so any misalignment may form an alignment error 52 which may adversely affect how corresponding score lines 32a,b are able to interact with one another. Specifically, alignment error 52 will typically, at a minimum, increase the amount of folding force required to form the container 60.

An additional aspect of the present invention is most prevalent when the blanks 38 and containers 60 are constructed from relatively thicker material, such as, double or triple wall corrugated material or in overlapped panels. Specifically, the relief regions 30a,b have been found to greatly reduce the amount of folding force required to form the container 60 with or without ,an alignment error 52. This is done by the relief profiles 34 partially relieving the tensional and compressive forces about the score lines within the relief region 30a,b.

FIGS. 4 and 5 depict a blank 38 and container 60, respectively, incorporating an aspect of the present invention. Both the blank 38 and container 60 are shown for illustrative purposes only and are not intended to limit the present invention to any specific blank 38 or container geometry, style or design. Exemplary blank 38 and resultant container 60 include a bottom panel 40 with opposed side panels 42, 42′. The bottom panel 40 also includes opposed bottom flaps 46, 46′. The side panels 42, 42′ may also include opposed side flaps 48, 48′. Further, the side panel 42, 42′ may also include an optional top panel 44, 44′. The top panels 44, 44′ may also include top panel flaps 50, 50′.

As depicted in the FIGURES, the relief regions 30a,b are shown on the score lines 32a,b between the side panels 42, 42′ and side flaps 48, 48′, between the top panels 44, 44′ and top panel flaps 50, 50′ and between the side panels 42, 42′ and top panels 44, 44′. However, it will be appreciated that relief regions 30a,b may be positioned along any score line 30a,b. Further, the relief sections 30a,b are not to be limited in overall size. Specifically, the relief sections 30a,b may be sized some fractional length of the associated score line 32a,b length or the relief sections 30a,b may be equal in length to the score lines 32a,b (not shown). As such, the size (length and width) and location of the relief sections 30a,b are purely a matter of design choice and are not intended to limit the scope of the present application.

Those skilled in the art will appreciate that the present invention may be used with any known blank and container style. For example, the present invention is usable to form any variety of slotted blank/container such as, regular, overlap, center special, center special overlap, full overlap, center special full overlap, half slotted container with cover, half slotted box with half slotted partial cover and full telescope half slotted box. Additionally, the present invention is usable with any style of box such as, design, double cover, bulk bin, bliss, recessed end, double thickness score line, double or triple side box. Further, the present invention is usable with additional blank or container items, for example, one, two or three piece folders, shells, tubes, partitions and any style of inner packing form.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of reducing container folding resistance, comprising:
forming a container blank having a panel, said panel including a score line; and,
interposing a relief region along the score line, said relief region including a plurality of arranged cuts that lie substantially transverse the score line,
wherein the score line is aligned with the relief region.
